(19) United States
(12) Patent Application Publication
(10) Pub. No.: US 2021/0010766 A1
(43) Pub. Date: Jan. 14, 2021

(54) Drive Train Assembly Thermal Management System

(71) Applicant: Atieva, Inc., Newark, CA (US)

(72) Inventor: Emad Dlala, Pleasanton, CA (US)

(73) Assignee: Atieva, Inc., Newark, CA (US)

(21) Appl. No.: 16/504,458

(22) Filed: Jul. 8, 2019

(51) Int. Cl. F28F 27/02; F28D 15/00; B60K 11/04; B60K 1/00

(52) U.S. Cl. CPC F28F 27/02; F28D 15/00; F28D 2021/0091; B60K 1/00; F28F 2250/06; B60K 11/04

(57) ABSTRACT

A multi-mode vehicle thermal management system is provided that optimizes drive train operating efficiency by thermally de-coupling the drive train thermal control loop from other vehicle thermal control loops during initial vehicle start-up when drive train coolant/lubricant is cold, thus taking into account the temperature dependence of the coolant/lubricant characteristics (e.g., viscosity and density) and the effects of these characteristics on viscous drag and bearing/seal preload force.

### FIELD OF THE INVENTION

The present invention relates generally to the electric drive train of an electric vehicle and, more particularly, to a thermal management system that can be used to manage the cooling and lubrication system associated with an electric vehicle's drive train, thereby reducing energy consumption.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. While some within the industry are attempting to achieve these goals by engineering more efficient internal combustion engines, others are incorporating hybrid or all-electric drive trains into their vehicle line-ups. To meet consumer expectations, however, the automobile industry must not only achieve a greener drive train, but must do so while maintaining reasonable levels of performance, range, reliability, safety and cost.

The most common approach to achieving a low emission, high efficiency car is through the use of a hybrid drive train in which an internal combustion engine (ICE) is combined with one or more electric motors. While hybrid vehicles provide improved gas mileage and lower vehicle emissions than a conventional ICE-based vehicle, due to their inclusion of an internal combustion engine they still emit harmful pollution, albeit at a reduced level compared to a conventional vehicle. Additionally, due to the inclusion of both an internal combustion engine and an electric motor(s) with its accompanying battery pack, the drive train of a hybrid vehicle is typically much more complex than that of either a conventional ICE-based vehicle or an all-electric vehicle, resulting in increased cost and weight. Accordingly, several vehicle manufacturers are designing vehicles that only utilize an electric motor, or multiple electric motors, thereby eliminating one source of pollution while significantly reducing drive train complexity.

In order to achieve the desired levels of performance and reliability in an electric vehicle the drive train assembly must be lubricated and cooled, with the temperature of the traction motor remaining within its specified operating range regardless of ambient conditions or how hard the vehicle is being driven. A variety of approaches have been used to try and meet these goals. For example, U.S. Pat. No. 7,156,195 discloses a cooling system for use with the electric motor of a vehicle. The refrigerant used in the cooling system passes through an in-shaft passage provided in the output shaft of the motor as well as the reduction gear shaft. A refrigerant reservoir is formed in the lower portion of the gear case while an externally mounted cooler is used to cool the refrigerant down to the desired temperature.

U.S. Pat. No. 7,489,057 discloses a rotor assembly cooling system utilizing a hollow rotor shaft. The coolant feed tube that injects the coolant into the rotor shaft is rigidly coupled to the rotor shaft using one or more support members. The coolant that is pumped through the injection tube flows against the inside surface of the rotor shaft, thereby extracting heat from the assembly. The coolant circuit includes a coolant reservoir. The coolant used to extract heat from the motor is also used to cool and lubricate the transmission in at least one disclosed embodiment.

Although the prior art discloses numerous techniques for maintaining the temperature of the drive train assembly, an improved thermal management system is needed that efficiently controls drive train assembly temperature. The present invention provides such a thermal management system.

### SUMMARY OF THE INVENTION

The present invention provides a multi-mode thermal management system that includes (i) a drive train thermal control loop, (ii) a second thermal control loop, (iii) a heat exchanger thermally coupled to both the drive train thermal control loop and to the second thermal control loop, and (iv) a bypass valve, where the bypass valve in a first operational mode thermally decouples the drive train thermal control loop from the second thermal control loop, and where the bypass valve in a second operational mode thermally couples the drive train thermal control loop to the second thermal control loop via the heat exchanger. The drive train thermal control loop includes a first circulation pump which circulates a first heat transfer fluid within the drive train thermal control loop, where the drive train thermal control loop is thermally coupled to a drive train assembly (e.g., vehicle propulsion motor(s), gear assembly, etc.). The second thermal control loop includes a second circulation pump which circulates a second heat transfer fluid, different from the first heat transfer fluid, within the second thermal control loop. The second thermal control loop is preferably thermally coupled to a power inverter. The bypass valve is configured to operate in the first operational mode when a temperature corresponding to the first heat transfer fluid is less than a preset temperature, and configured to operate in the second operational mode when the temperature corresponding to the first heat transfer fluid is greater than the preset temperature. The second thermal control loop may include a radiator and a fan configured to force air through the radiator. The first heat transfer fluid may consist of oil and the second heat transfer fluid may consist of water or water containing an additive (e.g., ethylene glycol, propylene glycol, etc.). The bypass valve may consist of a thermostatic valve or it may be controlled by a control system that monitors the temperature of the first heat transfer fluid.

In one aspect, the bypass valve may be coupled to the drive train thermal control loop, where the bypass valve in the first operational mode thermally decouples the drive train thermal control loop from the heat exchanger and allows the first heat transfer fluid within the drive train thermal control loop to bypass the heat exchanger, and where the bypass valve in the second operational mode thermally couples the drive train thermal control loop to the heat exchanger.

In another aspect, the bypass valve may be coupled to the second thermal control loop, where the bypass valve in the first operational mode thermally decouples the second thermal control loop from the heat exchanger and allows the second heat transfer fluid within the second thermal control loop to bypass the heat exchanger, and where the bypass valve in the second operational mode thermally couples the second thermal control loop to the heat exchanger.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 illustrates an exemplary thermal management system in accordance with the prior art;

FIG. 2 illustrates a second exemplary thermal management system in accordance with the prior art;

FIG. 3 graphically illustrates the relationship between temperature and both viscosity and density for a common drive train coolant/lubricant;

FIG. 4 illustrates a modification of the embodiment shown in FIG. 1 in which a valve assembly has been added to the drive train coolant loop in order to decouple the drive train coolant loop from other coolant loops;

FIG. 5 illustrates an alternate modification of the embodiment shown in FIG. 1 in which a valve assembly has been added to the power inverter coolant loop in order to decouple the drive train coolant loop from other coolant loops;

FIG. 6 illustrates a modification of the embodiment shown in FIG. 2 in which a valve assembly has been added to the drive train coolant loop in order to decouple the drive train coolant loop from other coolant loops; and

FIG. 7 illustrates an alternate modification of the embodiment shown in FIG. 2 in which a valve assembly has been added to the power inverter coolant loop in order to decouple the drive train coolant loop from other coolant loops.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations or components, these steps, calculations or components should not be limited by these terms, rather these terms are only used to distinguish one step, calculation or component from another. For example, a first calculation could be termed a second calculation, similarly, a first step could be termed a second step, similarly, a first component could be termed a second component, all without departing from the scope of this disclosure.

The cooling systems described and illustrated herein are generally designed for use in a vehicle using an electric motor, e.g., an electric vehicle. In the following text, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system. The term “battery pack” as used herein refers to an assembly of one or more batteries electrically interconnected to achieve the desired voltage and capacity, where the battery assembly is typically contained within an enclosure.

In an EV, typically the battery pack as well as several other components are coupled to an active thermal management system. The thermal management system may consist of a single coolant loop or of several coolant loops. When the thermal management system includes multiple coolant loops, the loops may operate independently or be interconnected, for example utilizing heat exchangers. Depending upon the coolant loop configuration and the components to be cooled, the coolant may consist of a traditional coolant (e.g., water with an additive such as ethylene glycol or propylene glycol), a refrigerant, or a coolant that is designed to provide lubrication as well as extract heat (e.g., oil). Typically a refrigerant is used with the passenger cabin's heating, ventilation and air conditioning (HVAC) system, a more traditional coolant is used for the battery pack and power inverter, and a lubricating coolant is used for the drive train assembly (e.g., motor and gear assembly).

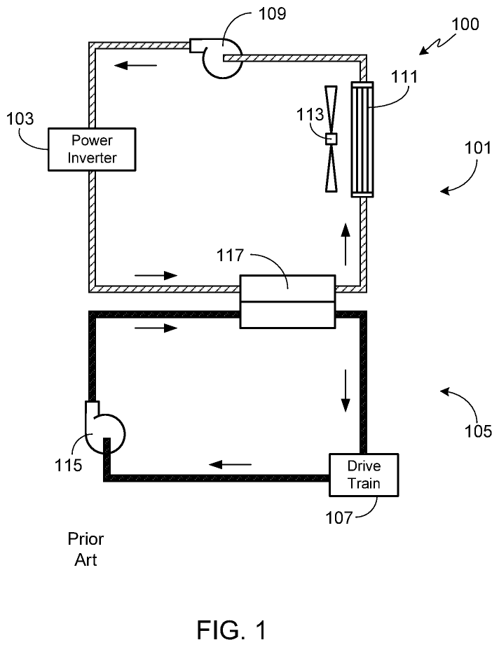

FIG. 1 illustrates an exemplary thermal management system 100 in accordance with the prior art. Thermal management system 100 includes a first coolant loop 101 configured to cool power inverter 103 and a second coolant loop 105 configured to cool and lubricate drive train assembly 107. Power inverter 103 converts the direct current (i.e., DC) power from the vehicle's battery pack (not shown) to match the power requirements of the propulsion motor(s) utilized in drive train assembly 107. Although not required, in addition to a propulsion motor(s) preferably drive train assembly 107 includes a gear assembly (e.g., single speed, fixed gear transmission or a multi-speed transmission) that is also cooled and lubricated via coolant loop 105.

Within coolant loop 101 the heat transfer fluid is circulated using coolant pump 109. Preferably the heat transfer fluid is water-based, e.g., pure water or water that includes an additive such as ethylene glycol or propylene glycol, although a non-water-based heat transfer fluid may also be used in coolant loop 101. Coolant loop 101 is thermally coupled to power inverter 103. In order to passively cool power inverter 103 as well as any other components directly coupled to coolant loop 101, the coolant is circulated through radiator 111. If there is insufficient air flow through radiator 111 to provide the desired level of passive cooling, for example when the vehicle is stopped or driving at low speeds, a fan 113 may be used to force air through the radiator.

Coolant loop 105, which is coupled to drive train assembly 107 as previously noted, uses a coolant pump 115 to circulate a coolant through drive train assembly 106, the coolant being capable of both extracting heat and lubricating the drive train as it circulates. The coolant used in loop 105 is non-gaseous and has the thermal and mechanical properties suitable for a motor coolant and lubricant, e.g., high heat capacity, high break-down temperature, relatively low viscosity, and a good lubricant in order to protect against drive train assembly wear and corrosion. For most motor designs it is also necessary that the coolant be electrically non-conductive. In the preferred embodiment oil is used as the coolant within loop 105.

In FIG. 1, coolant loops 101 and 105 are thermally coupled together using heat exchanger 117. As a result of heat exchanger 117, heat generated within one coolant loop is transferred from the coolant within that loop to the coolant within the other coolant loop, thereby raising the temperature of the coolant within the cooler of the two loops and lowering the temperature the temperature of the coolant within the hotter of the two loops.

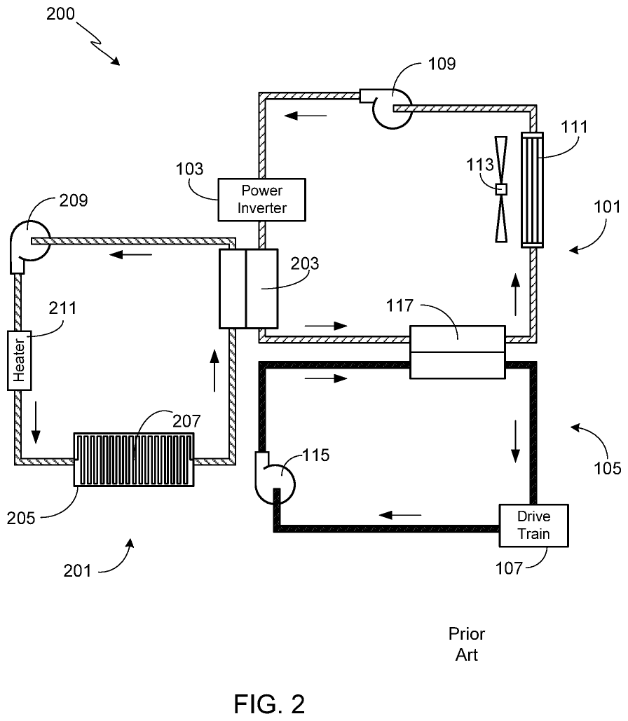

It will be appreciated that the exemplary thermal management system shown in FIG. 1 is a relatively simple system and that an EV may use a considerably more complex thermal management system in order to meet the heating and cooling requirements of the battery pack and the passenger cabin. For example, FIG. 2 illustrates a second exemplary thermal management system 200 in which coolant loop 101 is thermally coupled to a third coolant loop 201 via a second heat exchanger 203. In coolant loop 201, the temperature of the batteries within battery pack 205 is controlled by pumping a heat transfer fluid, e.g., a liquid coolant, through a plurality of cooling conduits 207 integrated into battery pack 205. Conduits 207, which are fabricated from a material with a relatively high thermal conductivity, are positioned within pack 205 in order to optimize thermal communication between the individual batteries, not shown, and the conduits, thereby allowing the temperature of the batteries to be regulated by regulating the flow of coolant within conduits 207 and/or regulating the transfer of heat from the coolant to another temperature control system. In the illustrated embodiment, the coolant within conduits 207 is pumped using a pump 209. This exemplary system also includes a heater 211, e.g., a PTC heater, which may be used to provide supplemental heating of the coolant within coolant loop 201.

The purpose of the thermal management system, regardless of its specific configuration, is to efficiently regulate the temperature of the various subsystems and components thermally coupled to the system, thereby optimizing performance of each. Thus, for example, a typical EV thermal management system must regulate the temperature within the passenger cabin, the battery pack, the drive train, and the power inverter in order to ensure that the passengers within the passenger cabin are comfortable and that the various EV subsystems (e.g., battery pack, drive train and power inverter) are operating at peak efficiency. In order to accomplish this goal, heat generated within one system is used to heat other systems while excess heat is rejected using active refrigeration systems as well as radiators and blower fans.

A common practice in an EV thermal management system, regardless of its exact configuration, is to thermally couple the power inverter coolant loop and the drive train assembly coolant loop via a heat exchanger as illustrated in FIGS. 1 and 2. As such when the EV is cold, i.e., after a period of non-use, heat generated by the drive train assembly heats both the drive train assembly coolant and the coolant within the power inverter coolant loop. Due to the additional thermal mass of the power inverter coolant loop, the coolant within the drive train coolant loop takes longer to reach an optimal operating temperature than would otherwise be the case if the drive train coolant loop was a completely independent thermal loop. The inventor has found that the additional time required to optimize the drive train assembly operating temperature using the conventional thermal management configuration adversely affects vehicle efficiency, especially in situations in which the vehicle is often driven for short periods of time and allowed to cool between uses.

In an electric motor, energy consumption varies based on the temperature of the coolant/lubricant, i.e., the coolant within coolant loop 105. The temperature dependence is due to (i) viscous drag (i.e., fluid resistance) and (ii) preload force (i.e., drag) on the drive train assembly's bearings and seals. Viscous drag, which affects both rotor rotation within the motor and rotation of the gears within the drive train's transmission, is dependent upon the viscosity of the oil, e.g., coolant, used to cool and lubricate the drive train. Low temperature also increases the preload force applied to the bearings and seals within the drive train, which results in lowering the efficiency. Additionally, it will be appreciated that viscous drag and bearing/seal preload force is also applicable to operation of the coolant pump used within the drive train assembly coolant loop, e.g., pump 115 in coolant loop 105.

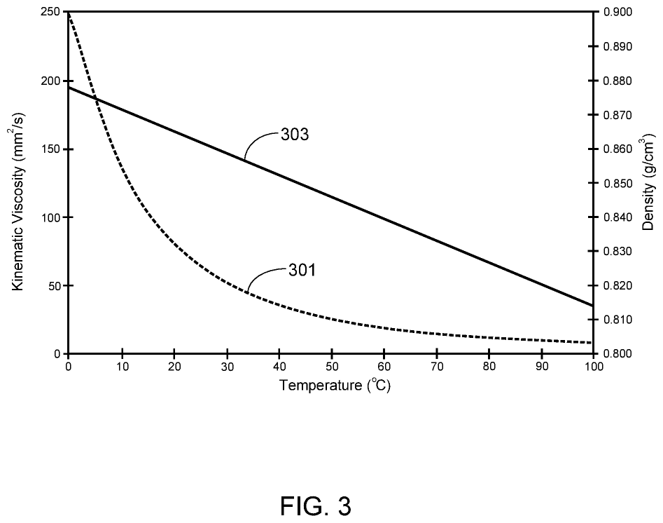

FIG. 3 graphically illustrates the relationship between temperature and both viscosity (i.e., curve 301) and density (i.e., curve 303) for a common oil used to cool and lubricate drive train assemblies. As shown, increasing the temperature of the oil leads to a significant decrease in both viscosity and density, thereby leading to improved drive train assembly efficiency. Increasing oil temperature also leads to lower power consumption by the coolant pump, further improving system efficiency.

In order to achieve the desired increase in drive train efficiency, and in accordance with the invention, a bypass valve is introduced into the thermal management system that effectively thermally decouples the drive train assembly coolant loop 105 from other coolant loops within the thermal management system. Introduction of the bypass valve allows the coolant within loop 105 to heat-up more rapidly. Accelerating the heat-up cycle of the coolant within loop 105 lowers drive train energy consumption which, in turn, leads to improved driving range.

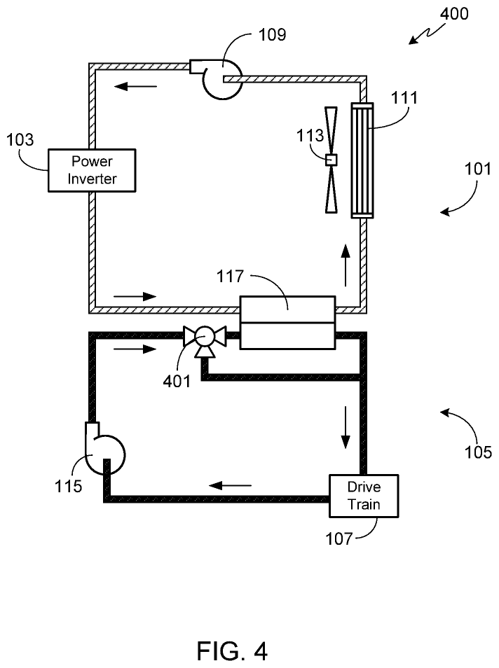

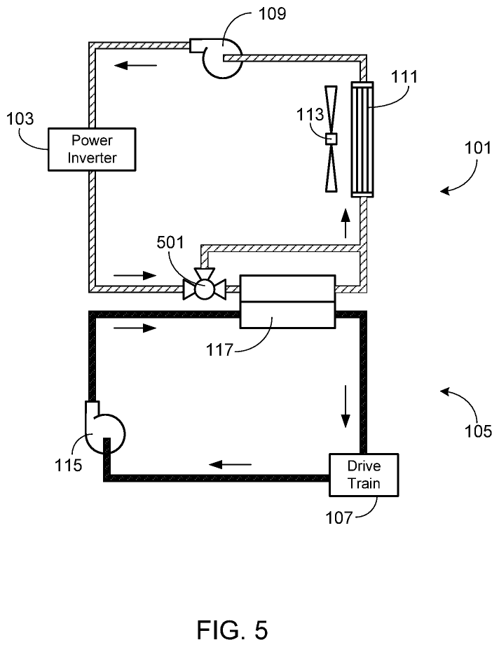

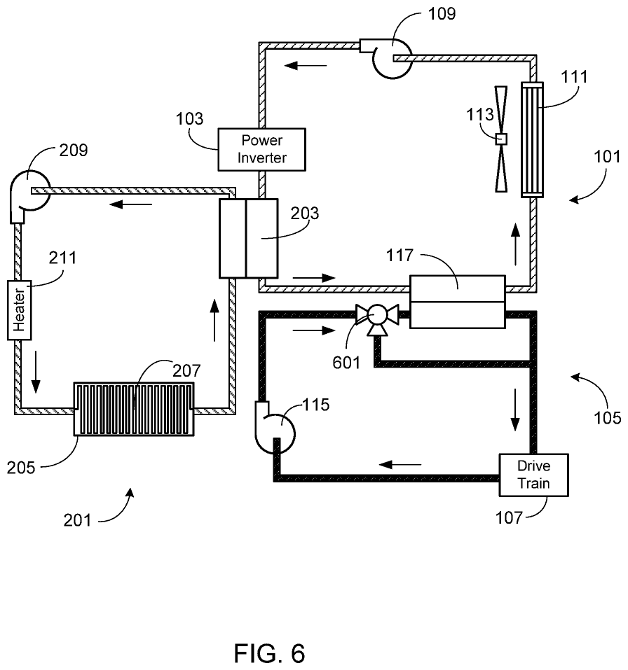

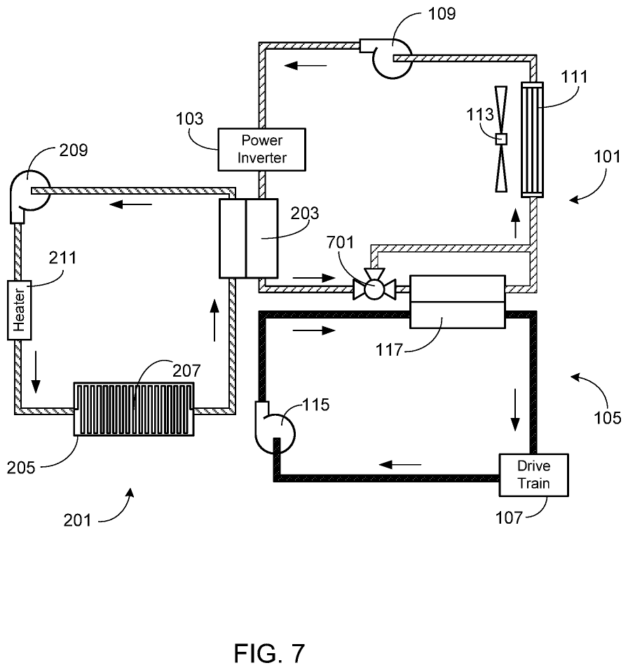

FIG. 4 illustrates an exemplary embodiment of the invention in which a bypass valve 401 is introduced into the drive train assembly coolant loop 105, thermal management system 400 being a modification of the system shown in FIG. 1. Valve 401 permits the coolant (e.g., oil) to bypass heat exchanger 117, thus allowing the coolant within loop 105 to heat up more quickly. The same effect can be achieved by introducing a bypass valve (e.g., bypass valve 501) into coolant loop 101 such that the heat exchanger is decoupled from the second coolant loop (i.e., loop 101), thereby effectively decoupling the drive train coolant loop from the power inverter coolant loop (see FIG. 5). It will be appreciated that the bypass valve is equally applicable to other thermal management systems that utilize a drive train coolant loop coupled to another thermal loop via a heat exchanger. For example, FIGS. 6 and 7 illustrate the inclusion of a bypass valve into the thermal management system shown in FIG. 2, the bypass valve decoupling the drive train coolant loop from other coolant loops within the thermal management system. In FIG. 6 a bypass valve 601 is introduced into coolant loop 105 while in FIG. 7 a bypass valve 701 is introduced into coolant loop 101, both configurations effectively thermally decoupling the drive train coolant loop from other coolant loops within the system.

Once the coolant within the drive train assembly coolant loop has reached the desired operating temperature, the bypass valve (e.g., valve 401, 501, 601, 701) is opened, thereby thermally coupling the coolant loop to the power inverter coolant loop via the heat exchanger (e.g., heat exchanger 117). Preferably the desired operating temperature is either set to the optimal operating temperature of the drive train assembly or set to a temperature that is sufficiently high to minimize the effects of coolant viscosity and density on the operating efficiency of the drive train assembly and coolant pump 115. In at least one embodiment the bypass valve is a thermostatic valve configured to open when the desired coolant temperature has been reached. Alternately the bypass valve may be controlled by a control system that monitors coolant temperature within coolant loop 105 and opens the bypass valve when the desired operating temperature has been reached.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A multi-mode thermal management system, comprising:
a drive train thermal control loop comprising a first circulation pump, wherein said first circulation pump circulates a first heat transfer fluid within said drive train thermal control loop, and wherein said drive train thermal control loop is thermally coupled to a drive train assembly;
a second thermal control loop comprising a second circulation pump, wherein said second circulation pump circulates a second heat transfer fluid within said second thermal control loop, wherein said second heat transfer fluid is comprised of a different coolant than said first heat transfer fluid;
a heat exchanger thermally coupled to said drive train thermal control loop and thermally coupled to said second thermal control loop, wherein said heat exchanger thermally couples said drive train thermal control loop to said second thermal control loop; and
a bypass valve, wherein said bypass valve in a first operational mode thermally decouples said drive train thermal control loop from said second thermal control loop, wherein said bypass valve in a second operational mode thermally couples said drive train thermal control loop to said second thermal control loop via said heat exchanger, wherein said bypass valve is configured to operate in said first operational mode when a temperature corresponding to said first heat transfer fluid is less than a preset temperature, and wherein said bypass valve is configured to operate in said second operational mode when said temperature corresponding to said first heat transfer fluid is greater than said preset temperature.

2. The multi-mode thermal management system of claim 1, wherein said bypass valve is coupled to said drive train thermal control loop, wherein said bypass valve in said first operational mode thermally decouples said drive train thermal control loop from said heat exchanger and allows said first heat transfer fluid within said drive train thermal control loop to bypass said heat exchanger, and wherein said bypass valve in said second operational mode thermally couples said drive train thermal control loop to said heat exchanger.

3. The multi-mode thermal management system of claim 2, wherein said drive train assembly is comprised of a vehicle propulsion motor.

4. The multi-mode thermal management system of claim 3, wherein said drive train assembly is further comprised of a gear assembly.

5. The multi-mode thermal management system of claim 2, wherein said second thermal control loop is thermally coupled to a power inverter.

6. The multi-mode thermal management system of claim 2, further comprising a radiator and a fan, said radiator coupled to said second thermal control loop and said fan configured to force air through said radiator.

7. The multi-mode thermal management system of claim 2, wherein said first heat transfer fluid consists of an oil.

8. The multi-mode thermal management system of claim 2, wherein said second heat transfer fluid is selected from the group consisting of water and water containing an additive.

9. The multi-mode thermal management system of claim 8, wherein said additive is selected from the group consisting of ethylene glycol and propylene glycol.

10. The multi-mode thermal management system of claim 2, wherein said bypass valve consists of a thermostatic valve.

11. The multi-mode thermal management system of claim 2, wherein said bypass valve is controlled by a control system, wherein said control system monitors said temperature corresponding to said first heat transfer fluid and switches said bypass valve between said first and second operational modes based on said temperature.

12. The multi-mode thermal management system of claim 1, wherein said bypass valve is coupled to said second thermal control loop, wherein said bypass valve in said first operational mode thermally decouples said second thermal control loop from said heat exchanger and allows said second heat transfer fluid within said second thermal control loop to bypass said heat exchanger, and wherein said bypass valve in said second operational mode thermally couples said second thermal control loop to said heat exchanger.

13. The multi-mode thermal management system of claim 12, wherein said drive train assembly is comprised of a vehicle propulsion motor.

14. The multi-mode thermal management system of claim 13, wherein said drive train assembly is further comprised of a gear assembly.

15. The multi-mode thermal management system of claim 12, wherein said second thermal control loop is thermally coupled to a power inverter.

16. The multi-mode thermal management system of claim 12, further comprising a radiator and a fan, said radiator coupled to said second thermal control loop and said fan configured to force air through said radiator.

17. The multi-mode thermal management system of claim 12, wherein said first heat transfer fluid consists of an oil.

18. The multi-mode thermal management system of claim 12, wherein said second heat transfer fluid is selected from the group consisting of water and water containing an additive.

19. The multi-mode thermal management system of claim 18, wherein said additive is selected from the group consisting of ethylene glycol and propylene glycol.

20. The multi-mode thermal management system of claim 12, wherein said bypass valve consists of a thermostatic valve.

21. The multi-mode thermal management system of claim 12, wherein said bypass valve is controlled by a control system, wherein said control system monitors said temperature corresponding to said first heat transfer fluid and switches said bypass valve between said first and second operational modes based on said temperature.
